(19) United States
(12) Patent Application Publication
(10) Pub. No.: US 2026/0281770 A1
(43) Pub. Date: Sep. 17, 2026

(54) Method and Apparatus for Applying Configuration at Terminal Device

(71) Applicant: Telefonaktiebolaget LM Ericsson (publ), Stockholm (SE)

(72) Inventors: Zhiqiang Qi, Beijing (CN); Helka-Liina Määttänen, Espoo (FI); Hieu Do, Järfälla (SE); Nithin Srinivasan, Köln (DE)

(21) Appl. No.: 19/156,950

(22) PCT Filed: Feb. 4, 2024
(86) PCT No.: PCT/CN2024/075778

§ 371 Date: Aug. 15, 2025

(30) Foreign Application Priority Data
Feb. 17, 2023 (WO) PCT/CN2023/076788

(51) Int. Cl. H04W 24/10; H04B 17/318

(52) U.S. Cl. CPC H04W 24/10; H04B 17/328

(57) ABSTRACT

Embodiments of the present disclosure provide a method and an apparatus for applying configuration at terminal device. A method (100) performed by a terminal device comprises: receiving (S102), from a network node, a measurement configuration associated with a condition; and performing (S106) a measurement and/or transmitting (S108) a report based on the measurement configuration, when the condition is met. The condition is related to a first height/altitude range and/or a time period that the terminal device is in or out of a first height/altitude range. By associating a measurement configuration to a condition, the measurement configuration can be active only when the condition is met. Therefore, the measurement configuration may be configured previously but applied later based on the condition.

### TECHNICAL FIELD

The present disclosure relates generally to the technology of communication network, and in particular, to a method and an apparatus for applying configuration at terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

In a communication system, it is important for the network side to understand the situation of a terminal device (such as about the terminal device itself or the circumstance of the terminal device) and configure the terminal device correspondingly, so as to better arrange communication resource (such as time and frequency resources), and thus provide better service to the terminal device. For example, the network side may configure a terminal device in a coverage to perform measurements and then report, under various conditions.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A terminal device connected to a wireless communication network may experience a variety of radio conditions, particularly during movement. The same configuration for the terminal device will not be appropriate to all of these different radio conditions.

Certain aspects of the present disclosure and their embodiments may provide solutions to these or other challenges. There are, proposed herein, various embodiments which address one or more of the issues disclosed herein.

A first aspect of the present disclosure provides a method performed by a terminal device. The method comprises: receiving, from a network node, a measurement configuration associated with a condition; and performing a measurement and/or transmitting a report based on the measurement configuration, when the condition is met. The condition is related to a first height/altitude range and/or a time period that the terminal device is in or out of a first height/altitude range.

In exemplary embodiments of the present disclosure, the method further comprises: determining whether the condition is met.

In exemplary embodiments of the present disclosure, the measurement configuration includes a first set of configuration parameters, and a second set of configuration parameters. The condition includes a first condition and a second condition. The first set of configuration parameters is associated with the first condition. The second set of configuration parameters is associated with the second condition.

In exemplary embodiments of the present disclosure, the terminal device performs a measurement and/or transmits a report based on the first set of configuration parameters, when the first condition is met. The terminal device performs a measurement and/or transmits a report based on the second set of configuration parameters, when the second condition is met.

In exemplary embodiments of the present disclosure, the measurement configuration is associated with a measurement configuration identity.

In exemplary embodiments of the present disclosure, the measurement configuration, identified by the measurement configuration identity, is pre-configured for the condition. The method further comprises: transmitting, to the network node, a request for an update to the measurement configuration indicated by the measurement configuration identity.

In exemplary embodiments of the present disclosure, the first height/altitude range is indicated by at least one parameter. The at least one parameter comprises: a height/altitude with an offset, a bottom threshold of height/altitude, and/or a top threshold of height/altitude.

In exemplary embodiments of the present disclosure, the measurement configuration includes at least one parameter indicating a second height/altitude range. The method further comprises: determining the condition as being met, when the second height/altitude range overlaps with the first height/altitude range.

In exemplary embodiments of the present disclosure, the method further comprises: receiving, from the network node, a reconfiguration for the measurement. The reconfiguration is triggered based on an event related to a height/altitude of the terminal device.

In exemplary embodiments of the present disclosure, the condition is further related to at least one of: a speed of the terminal device, a location of the terminal device, a time, and/or a signal characteristic measured by the terminal device.

In exemplary embodiments of the present disclosure, the measurement configuration comprises at least one of: a measurement object, a report interval, a report amount, a maximal number of report cells, an event threshold, an event hysteresis, and/or a time to trigger related to an event.

In exemplary embodiments of the present disclosure, an event hysteresis is configured for at least one event threshold.

In exemplary embodiments of the present disclosure, a reference signal received power, RSRP, or a reference signal received quality, RSRQ, measurement is reported, when the condition is met.

In exemplary embodiments of the present disclosure, the measurement configuration comprises a list of height/altitude ranges. A height/altitude range in the list of height/altitude ranges is indicated by a combination of a minimum height/altitude, a maximum height/altitude, and/or a hysteresis for height/altitude.

In exemplary embodiments of the present disclosure, the measurement configuration indicates that, the terminal device measures a synchronization signal block, SSB, corresponding to a height/altitude range, when the terminal device is within the height/altitude range.

In exemplary embodiments of the present disclosure, the terminal device is a user equipment, UE. The network node is a base station.

In exemplary embodiments of the present disclosure, the terminal device is an aerial UE.

A second aspect of the present disclosure provides a method performed by a network node. The method comprises: transmitting, to a terminal device, a measurement configuration associated with a condition. The condition is related to a first height/altitude range and/or a time period that the terminal device is in or out of a first height/altitude range. The condition is used for the terminal device to perform a measurement and/or transmit a report based on the measurement configuration, when the condition is met.

In exemplary embodiments of the present disclosure, the condition is used for the terminal device to determine whether the condition is met.

In exemplary embodiments of the present disclosure, the measurement configuration includes a first set of configuration parameters, and a second set of configuration parameters. The condition includes a first condition and a second condition. The first set of configuration parameters is associated with the first condition. The second set of configuration parameters is associated with the second condition.

In exemplary embodiments of the present disclosure, the terminal device performs a measurement and/or transmits a report based on the first set of configuration parameters, when the first condition is met. The terminal device performs a measurement and/or transmits a report based on the second set of configuration parameters, when the second condition is met.

In exemplary embodiments of the present disclosure, the measurement configuration is associated with a measurement configuration identity.

In exemplary embodiments of the present disclosure, the measurement configuration, identified by the measurement configuration identity, is pre-configured for the condition. The method further comprises: receiving, from the terminal device, a request for an update to the measurement configuration indicated by the measurement configuration identity.

In exemplary embodiments of the present disclosure, the first height/altitude range is indicated by at least one parameter. The at least one parameter comprises: a height/altitude with an offset, a bottom threshold of height/altitude, and/or a top threshold of height/altitude.

In exemplary embodiments of the present disclosure, the measurement configuration includes at least one parameter indicating a second height/altitude range. The terminal device determines the condition as being met, when the second height/altitude range overlaps with the first height/altitude range.

In exemplary embodiments of the present disclosure, the method further comprises: transmitting, to the terminal device, a reconfiguration for the measurement. The reconfiguration is triggered based on an event related to a height/altitude of the terminal device.

In exemplary embodiments of the present disclosure, the condition is further related to at least one of: a speed of the terminal device, a location of the terminal device, a time, and/or a signal characteristic measured by the terminal device.

In exemplary embodiments of the present disclosure, the measurement configuration comprises at least one of: a measurement object, a report interval, a report amount, a maximal number of report cells, an event threshold, an event hysteresis, and/or a time to trigger related to an event.

In exemplary embodiments of the present disclosure, an event hysteresis is configured for at least one event threshold.

In exemplary embodiments of the present disclosure, a reference signal received power, RSRP, or a reference signal received quality, RSRQ, measurement is reported, when the condition is met.

In exemplary embodiments of the present disclosure, the measurement configuration comprises a list of height/altitude ranges. A height/altitude range in the list of height/altitude ranges is indicated by a combination of a minimum height/altitude, a maximum height/altitude, and/or a hysteresis for height/altitude.

In exemplary embodiments of the present disclosure, the measurement configuration indicates that, the terminal device measures a synchronization signal block, SSB, corresponding to a height/altitude range, when the terminal device is within the height/altitude range.

In exemplary embodiments of the present disclosure, the terminal device is a user equipment, UE. The network node is a base station.

In exemplary embodiments of the present disclosure, the terminal device is an aerial UE.

A third aspect of the present disclosure provides an apparatus for a terminal device. The apparatus for the terminal device comprises: a processor; a memory, the memory containing instructions executable by the processor. The apparatus for the terminal device is operative for: receiving, from a network node, a measurement configuration associated with a condition; and performing a measurement and/or transmitting a report based on the measurement configuration, when the condition is met. The condition is related to a first height/altitude range and/or a time period that the terminal device is in or out of a first height/altitude range.

In exemplary embodiments of the present disclosure, the apparatus may be further operative to perform the method according to any of above embodiments.

A fourth aspect of the present disclosure provides an apparatus for a network node. The apparatus for the network node comprises: transmitting, to a terminal device, a measurement configuration associated with a condition. The condition is related to a first height/altitude range and/or a time period that the terminal device is in or out of a first height/altitude range. The condition is used for the terminal device to perform a measurement and/or transmit a report based on the measurement configuration, when the condition is met.

In exemplary embodiments of the present disclosure, the apparatus may be further operative to perform the method according to any of above embodiments.

A fifth aspect of the present disclosure provides computer-readable storage medium storing instructions, which when executed by at least one processor, causes the at least one processor to perform the method according to any of above embodiments.

Embodiments herein afford many advantages. According to embodiments of the present disclosure, improved methods and improved apparatuses for applying configuration at terminal device are provided.

By associating a measurement configuration to a condition, the measurement configuration can be active only when the condition is met. Therefore, the measurement configuration may be configured previously but applied later based on the condition. Further, different measurement configuration may be applied at terminal device for different conditions. The terminal device may be configured more accurately and appropriately based on the condition. For example, inaccurate and excessive measurement reporting may be avoided.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is an exemplary flow chart for a method performed by a terminal device, according to exemplary embodiments of the present disclosure.

FIG. 1B is an exemplary flow chart showing additional steps of the method in FIG. 1A, according to exemplary embodiments of the present disclosure.

FIG. 2A is an exemplary flow chart for a method performed by a network node, according to exemplary embodiments of the present disclosure.

FIG. 2B is an exemplary flow chart showing additional steps of the method in FIG. 2A, according to exemplary embodiments of the present disclosure.

FIG. 3 is a diagram showing different measurement configurations associated with different conditions.

FIG. 4 is a block diagram showing an exemplary apparatus for a terminal device, which is suitable for performing the method according to embodiments of the disclosure.

FIG. 5 is a block diagram showing an exemplary apparatus for a network node, which is suitable for performing the method according to embodiments of the disclosure.

FIG. 6 is a block diagram showing a communication system including a terminal device and a network node.

FIG. 7 is a block diagram showing an apparatus/computer readable storage medium, according to embodiments of the present disclosure.

FIG. 8 is a block diagram showing modules for a terminal device, which are suitable for performing the method according to embodiments of the disclosure.

FIG. 9 is a block diagram showing modules for a network node, which are suitable for performing the method according to embodiments of the disclosure.

FIG. 10 shows an example of a communication system 1000 in accordance with some embodiments.

FIG. 11 shows a UE 1100 in accordance with some embodiments.

FIG. 12 shows a network node 1200 in accordance with some embodiments.

FIG. 13 is a block diagram of a host 1300, which may be an embodiment of the host 1016 of FIG. 10, in accordance with various aspects described herein.

FIG. 14 is a block diagram illustrating a virtualization environment 1400 in which functions implemented by some embodiments may be virtualized.

FIG. 15 shows a communication diagram of a host 1502 communicating via a network node 1504 with a UE 1506 over a partially wireless connection in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable communication standards (such as an internet network, or any wireless network). For example, wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node”, “network function”, “network entity” herein may also refer to any suitable node, function, entity which can be implemented (physically or virtually) in a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device/communication device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP’ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

It should be understood, the terminal device may be also applied in any other situation. For example, it may be arranged indoor, or outdoor, with or without mobility. For example, the communication device could also be mounted on drone or other mobility scenarios. It may be a mobile device such as a portable computer, or a mobile phone.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

In a lot of implementation scenarios, a movement of the terminal device during access to the communication networks is very important. For example, the world is witnessing a widespread and increasing use of drones, or more technically the Unmanned Aerial Vehicles (UAV), in many segments of the economy and in our daily life. There are numerous use cases of UAVs in industry, goods transportation and delivery, surveillance, media production, etc.

Traditionally, the UAVs can only be flown by a controller within the visual line of sight (VLoS). Realizing the great potential of connecting drones beyond visual line of sight (BVLoS) via cellular network, 3GPP have specified multiple features in LTE release (Rel)-15, aiming at improving the efficiency and robustness of terrestrial LTE network for providing aerial connectivity services, particularly for low altitude UAVs. These features target both command-and-control traffic for flying the drone and the data (also known as payload) traffic from the drone to the cellular network. The key features specified include:
Support for subscription-based identification.
Height reporting when UAV crosses height threshold. The report includes height, location (3D), horizontal and vertical speed.
RSRP reporting per event of N cells' signal power above a threshold. The report includes RSRP/RSRQ/location(3D).
UE-specific UL power control.
Flight path information provided from UE to eNB. This includes network polling and list of waypoints (3D location), time stamp if available.

These features were introduced targeting special needs when serving the UAVs by LTE network, e.g., the need for flying mode detection, interference detection, and interference mitigation.

In Rel-18, 3GPP is working on porting the above features from LTE to the NR interface. Besides, some features related to broadcasting the UAV identity and support for directional antennas at the UAVs are also being added.

Note that so far in 3GPP the UAV communications mostly concerns the Uu interface (i.e., uplink and downlink), but in the coming releases starting from Rel-18, the UAV communications in the PC5 (a.k.a. Sidelink) interface will also be standardized. PC5-based UAV communication can be used for broadcasting the UAV ID or for the purpose of detect and avoid (DAA).

Configuration for measurement reporting is an important issue.

In a wireless network, the UE needs to measure the signal quality of the cell to perform cell selection or cell re-selection. While the UE is in RRC_Connected mode, it will report the measured results to the network. The above procedures are performed based on the measurement configuration from the network, which includes the following parameters:
Measurement objects: A list of objects on which the UE shall perform the measurements.
Reporting configuration: A list of reporting configurations where there can be one or multiple reporting configurations per measurement object. Each measurement reporting configuration consists of the following:
   Reporting criterion: The criterion that triggers the UE to send a measurement report. This can either be periodical or a single event description.
   RS type: The RS that the UE uses for beam and cell measurement results (SS/PBCH block or CSI-RS).
   Reporting format: The quantities per cell and per beam that the UE includes in the measurement report (e.g. RSRP) and other associated information such as the maximum number of cells and the maximum number beams per cell to report.
   In case of conditional reconfiguration, each configuration consists of the following:
   Execution criteria: The criteria the UE uses for conditional reconfiguration execution.
   RS type: The RS that the UE uses for obtaining beam and cell measurement results (SS/PBCH block-based or CSI-RS-based), used for evaluating conditional reconfiguration execution condition.

Measurement identities: For measurement reporting, a list of measurement identities where each measurement identity links one measurement object with one reporting configuration.

Quantity configurations: The quantity configuration defines the measurement filtering configuration used for all event evaluation and related reporting, and for periodical reporting of that measurement.

Measurement gaps: Periods that the UE may use to perform measurements.

A UE in RRC_CONNECTED maintains a measurement object list, a reporting configuration list, and a measurement identities list according to the 3GPP specification.

Height Triggered Measurement report is further introduced for aerial UEs.

Compared with terrestrial UEs, aerial UEs are more likely to receive higher downlink interference and create higher uplink interference. Hence it is critical to be aware of the airborne status of the aerial UE (i.e. whether the aerial UE is flying in the air) and make height dependent adjustment to mitigate the interference or improve the performance of mobility. In Rel-15 two new events were specified for height-triggered measurement reports, namely:
Event H1: The aerial UE height is above a threshold.
Event H2: The aerial UE height is below a threshold.

It has already been agreed in RAN2 meeting that introducing similar event H1 and event H2 with LTE principle as a baseline. These events help the network detect that a UE is in the flying mode and thereby the network can have further actions to facilitate such operation, such as adapting the number of resources scheduled to the UE and/or having other measures to handle the interference to/from the flying UE.

Since the aerial UE can fly high up to 300 meters as supported by LTE Rel-15, it may experience a variety of radio conditions in the air. For different heights/altitudes for aerial UEs, applying the same RRM configuration seems not appropriate at least for some parameters that are sensitive to UE height/altitude.

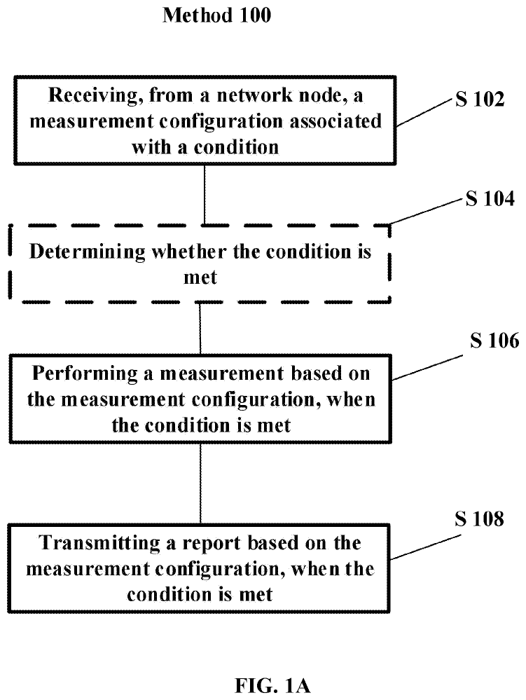

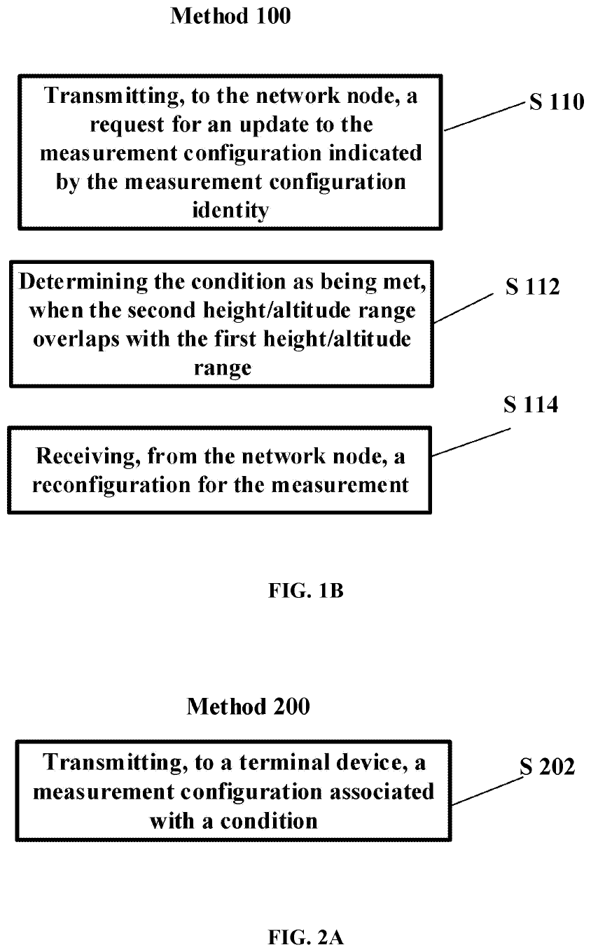

FIG. 1A is an exemplary flow chart for a method performed by a terminal device, according to exemplary embodiments of the present disclosure.

As shown in the FIG. 1A, the method 100 comprises: a step S102, receiving, from a network node, a measurement configuration associated with a condition; an optional step S104, determining whether the condition is met; and a step S106, performing a measurement and/or a step S108, transmitting a report based on the measurement configuration, when the condition is met. The condition is related to a first height/altitude range and/or a time period that the terminal device is in or out of a first height/altitude range.

For example, when the condition is met, a UE may start to perform measurements over a measurement object configured in the measurement configuration. Additionally, after obtaining the measurement result, the UE may transmit a report of the measurement based on parameters for report in the measurement configuration. For example, the UE may transmit the report periodically, and/or when an event in the measurement configuration is further triggered.

According to embodiments of the present disclosure, by associating a measurement configuration to a condition, the measurement configuration can be active only when the condition is met. Therefore, the measurement configuration may be configured previously but applied later based on the condition. Further, different measurement configuration may be applied at terminal device for different conditions. The terminal device may be configured more accurately and appropriately based on the condition. For example, inaccurate and excessive measurement reporting may be avoided.

According to embodiments of the present disclosure, the condition may be related to the height/altitude. Thus, it will be particularly useful for these terminal devices with movement in the height/altitude direction, since the movement in the height/altitude direction usually cause relatively bigger changes/interference for radio quality.

In exemplary embodiments of the present disclosure, the measurement configuration includes a first set of configuration parameters, and a second set of configuration parameters. The condition includes a first condition and a second condition. The first set of configuration parameters is associated with the first condition. The second set of configuration parameters is associated with the second condition.

In exemplary embodiments of the present disclosure, the terminal device performs a measurement and/or transmits a report based on the first set of configuration parameters, when the first condition is met. The terminal device performs a measurement and/or transmits a report based on the second set of configuration parameters, when the second condition is met.

According to embodiments of the present disclosure, one measurement configuration may include more than one set of configuration parameters associated with more than on conditions. Different sets of configuration parameters can be applied based on different conditions.

In exemplary embodiments of the present disclosure, the measurement configuration is associated with a measurement configuration identity.

For example, a plurality of measurement configuration identities may be associated with a plurality of conditions, respectively. Additionally or alternatively, when a measurement configuration identity indicates a measurement configuration including more than one set of configuration parameters, the measurement configuration identity may be associated with more than one condition.

FIG. 1B is an exemplary flow chart showing additional steps of the method in FIG. 1A, according to exemplary embodiments of the present disclosure.

In exemplary embodiments of the present disclosure, the measurement configuration, identified by the measurement configuration identity, is pre-configured for the condition. The method 100 further comprises: a step S110, transmitting, to the network node, a request for an update to the measurement configuration indicated by the measurement configuration identity.

According to embodiments of the present disclosure, some measurement configuration identity may be previously configured as being associated to height/altitude condition, such as defined in a standard.

In exemplary embodiments of the present disclosure, the first height/altitude range is indicated by at least one parameter. The at least one parameter comprises: a height/altitude with an offset, a bottom threshold of height/altitude, and/or a top threshold of height/altitude.

In exemplary embodiments of the present disclosure, the measurement configuration includes at least one parameter indicating a second height/altitude range. The method 100 further comprises: a step S112, determining the condition as being met, when the second height/altitude range overlaps with the first height/altitude range.

According to embodiments of the present disclosure, when both of the condition and the associated measurement configuration are related to height/altitude, the condition may be directly determined as being met or not met in some situations, for avoiding conflict/complication.

In exemplary embodiments of the present disclosure, the method 100 further comprises: a step S114, receiving, from the network node, a reconfiguration for the measurement. The reconfiguration is triggered based on an event related to a height/altitude of the terminal device.

According to embodiments, configuration parameters may be also updated/reconfigured by the network node.

In exemplary embodiments of the present disclosure, the condition is further related to at least one of: a speed of the terminal device, a location of the terminal device, a time, and/or a signal characteristic measured by the terminal device.

In exemplary embodiments of the present disclosure, the measurement configuration comprises at least one of: a measurement object, a report interval, a report amount, a maximal number of report cells, an event threshold, an event hysteresis, and/or a time to trigger related to an event.

In exemplary embodiments of the present disclosure, an event hysteresis is configured for at least one event threshold.

In exemplary embodiments of the present disclosure, a reference signal received power, RSRP, or a reference signal received quality, RSRQ, measurement is reported, when the condition is met.

In exemplary embodiments of the present disclosure, the measurement configuration comprises a list of height/altitude ranges. A height/altitude range in the list of height/altitude ranges is indicated by a combination of a minimum height/altitude, a maximum height/altitude, and/or a hysteresis for height/altitude.

In exemplary embodiments of the present disclosure, the measurement configuration indicates that, the terminal device measures a synchronization signal block, SSB, corresponding to a height/altitude range, when the terminal device is within the height/altitude range.

In exemplary embodiments of the present disclosure, the terminal device is a user equipment, UE. The network node is a base station.

In exemplary embodiments of the present disclosure, the terminal device is an aerial UE.

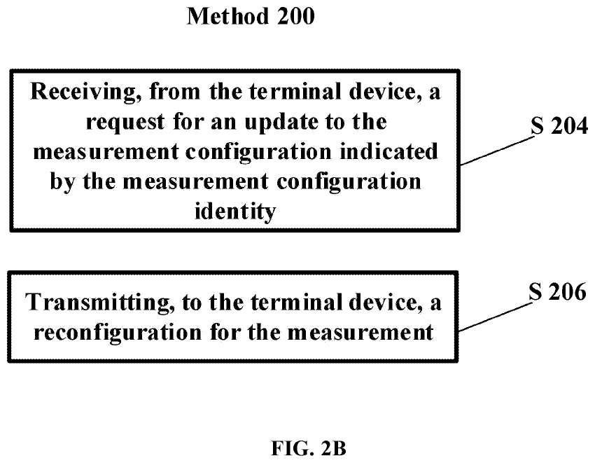

FIG. 2A is an exemplary flow chart for a method performed by a network node, according to exemplary embodiments of the present disclosure.

As shown in FIG. 2A, the method 200 comprises: a step S202, transmitting, to a terminal device, a measurement configuration associated with a condition. The condition is related to a first height/altitude range and/or a time period that the terminal device is in or out of a first height/altitude range. The condition is used for the terminal device to perform a measurement and/or transmit a report based on the measurement configuration, when the condition is met.

In exemplary embodiments of the present disclosure, the condition is used for the terminal device to determine whether the condition is met.

In exemplary embodiments of the present disclosure, the measurement configuration includes a first set of configuration parameters, and a second set of configuration parameters. The condition includes a first condition and a second condition. The first set of configuration parameters is associated with the first condition. The second set of configuration parameters is associated with the second condition.

In exemplary embodiments of the present disclosure, the terminal device performs a measurement and/or transmits a report based on the first set of configuration parameters, when the first condition is met. The terminal device performs a measurement and/or transmits a report based on the second set of configuration parameters, when the second condition is met.

In exemplary embodiments of the present disclosure, the measurement configuration is associated with a measurement configuration identity.

FIG. 2B is an exemplary flow chart showing additional steps of the method in FIG. 2A, according to exemplary embodiments of the present disclosure.

In exemplary embodiments of the present disclosure, the measurement configuration, identified by the measurement configuration identity, is pre-configured for the condition. The method 200 further comprises: a step S204, receiving, from the terminal device, a request for an update to the measurement configuration indicated by the measurement configuration identity.

In exemplary embodiments of the present disclosure, the first height/altitude range is indicated by at least one parameter. The at least one parameter comprises: a height/altitude with an offset, a bottom threshold of height/altitude, and/or a top threshold of height/altitude.

In exemplary embodiments of the present disclosure, the measurement configuration includes at least one parameter indicating a second height/altitude range. The terminal device determines the condition as being met, when the second height/altitude range overlaps with the first height/altitude range.

In exemplary embodiments of the present disclosure, the method 200 further comprises: a step S206, transmitting, to the terminal device, a reconfiguration for the measurement. The reconfiguration is triggered based on an event related to a height/altitude of the terminal device.

In exemplary embodiments of the present disclosure, the condition is further related to at least one of: a speed of the terminal device, a location of the terminal device, a time, and/or a signal characteristic measured by the terminal device.

In exemplary embodiments of the present disclosure, the measurement configuration comprises at least one of: a measurement object, a report interval, a report amount, a maximal number of report cells, an event threshold, an event hysteresis, and/or a time to trigger related to an event.

In exemplary embodiments of the present disclosure, an event hysteresis is configured for at least one event threshold.

In exemplary embodiments of the present disclosure, a reference signal received power, RSRP, or a reference signal received quality, RSRQ, measurement is reported, when the condition is met.

In exemplary embodiments of the present disclosure, the measurement configuration comprises a list of height/altitude ranges. A height/altitude range in the list of height/altitude ranges is indicated by a combination of a minimum height/altitude, a maximum height/altitude, and/or a hysteresis for height/altitude.

In exemplary embodiments of the present disclosure, the measurement configuration indicates that, the terminal device measures a synchronization signal block, SSB, corresponding to a height/altitude range, when the terminal device is within the height/altitude range.

In exemplary embodiments of the present disclosure, the terminal device is a user equipment, UE. The network node is a base station.

In exemplary embodiments of the present disclosure, the terminal device is an aerial UE.

According to exemplary embodiments of the present disclosure, this solution particularly proposes details on height/altitude dependent measurement reporting configuration for aerial UEs, which means for the aerial UEs within certain height/altitude range, one or more configuration for measurement reporting can be selected according to the height/altitude of the aerial UEs.

The proposed height/altitude dependent measurement reporting configuration introduces one or more measurement reporting configuration for the aerial UEs within certain height/altitude range and describes how the configurations are adopted, as well as some candidate parameters which could be included in the configuration sets. Also, other approaches are presented on how the measurement and reporting of the UE can be controlled via the RRC configuration.

Advantageously, the proposed height/altitude dependent measurement reporting configuration can provide several candidate measurement reporting configurations for aerial UEs within certain height/altitude range and optimize the RRM configuration by adapting to the height/altitude of UEs.

For better understanding, further detailed embodiments related to UAV will be illustrated below. It should be noted that UAV is just used as an example, any other kind of terminal devices, such as mobile phone, vehicle may be also used.

The overall procedure described is related to changing/updating/reconfiguring the measurement report configuration based on the (current) height/altitude of the UAV. A particular measurement report configuration as described in the specification is represented as a measID with certain parameters associated to it configured in the IE ReportConfigNR. An example of a measurement configuration from the network can consist of a periodic report configuration with a measID1 and an event/conditional event-based configuration with a measID2. In this example, for a height/altitude-dependent measurement configuration, the network can configure either of the following.

As a case1, the network can configure different measIDs (for periodic/event/conditional event-based report configurations) for different height/altitudes.

As a case2, the network can configure the same measID (for periodic/event/conditional event-based report configurations) with more than one value of one or more parameter in the ReportConfigNR corresponding to different height/altitudes.

As a case3, the network can configure one measID (for periodic/event/conditional event-based report configurations) for a particular height/altitude. Then upon request from the UAV, the network can provide an updated configuration.

In cases 1 and 2, the UAV can autonomously switch to another measID (case 1) or apply for the same measID a different value (case 2) depending on the height/altitude. In addition, for case 2, although multiple values are configured for the same measID, from the perspective of the network it is a single configuration with multiple values. However, from the perspective of the UAV in case 2, when applying a different value based on height/altitude, it can be considered as applying a reconfiguration based on the height/altitude.

In one embodiment, there is a parameter, or set of parameters (sub IE), in the IE ReportConfigNR which informs the UE on whether the ReportConfig has a height/altitude or speed limitation. For example, it may be that a ReportConfig associated to measID is valid only up to certain height/altitude. Or, height/altitude+offset, or when height/altitude+offset has been exceeded for a period of time which is also configured. If UE exceeds the condition, UE does not follow a first ReportConfig associated a first MeasId any longer but starts to apply a second ReportConfiguration associatied to second MeasId. Whether UE discards the measurements or derived measurements, e.g L3 filter output, may be configurable, or may be left to UE implementation, or may be specified in a fixed manner.

In the procedural part of RRC, such as in clause 5.5.4 of TS 38.331, V17.1.0, UE would have to check for each MeasID whether the e.g. height/altitude condition is valid for the reportConfig associated to that measId.

In one example embodiment, UE may be configured to stop periodical measurement reporting if UE exceeds certain height/altitude. This may be implemented in similar way as above where the first ReportConfig associated to first measid configures UE with periodical reporting but the second ReportConfig associated to the second measID does not have periodical reporting configured to the UE. It may also be specified that within one ReportConfig associated to one measID, there is height/altitude threshold within the periodical reporting and when UE exceeds the threshold (goes above or below), UE stops the periodical reporting. Alternatively, the periodical reporting may start to follow another periodicity.

In one embodiment, at least one of the following parameters can be included in the one example of the height/altitude dependent measurement reporting configuration:
For periodical report configuration, the following parameters can be configured as height/altitude dependent:
   Report interval: The interval between periodical reports;
   Report amount: Number of measurement reports;
   Maximal number of report cells: Maximal number of non-serving cells to include in the measurement report.
For event/conditional event triggered report configuration, the following parameters can be configured as height/altitude dependent:
   Report interval: The interval between periodical reports;
   Report amount: Number of measurement reports;
   Maximal number of report cells: Maximal number of non-serving cells to include in the measurement report;
   Event threshold: Threshold value associated to the selected trigger quantity (e.g. RSRP, RSRQ, SINR) per RS Type (e.g. SS/PBCH block, CSI-RS) to be used in NR measurement report triggering condition for an event;
   Event hysteresis: Used within the entry and leave condition of an event triggered reporting condition;
   Event timeToTrigger: Time during which specific criteria for the event needs to be met in order to trigger a measurement report.

In one embodiment, UE is configured within one ReportConfig associated with one MeasId with more than one value of one of the above mentioned parameters such that the value depends on heigh threshold.

In another embodiment, when the UE is configured with both at least one of the height/altitude dependent measurement reporting configuration and height/altitude-triggered events (H1/H2), the UE can skip the report config conditioned by certain height/altitude. Optionally, the UE skip the height/altitude-dependent report configuration if this height/altitude is the same as or close to the height/altitude threshold that triggers the height/altitude-triggered events.

For example, for eliminating conflict/complication in such conditions, the UE may always directly determine that the height/altitude condition is met (or the UE may always directly determine that the height/altitude condition is not met), without considering the actual value of the height/altitude.

In one embodiment, the network can configure the UE with height/altitude-dependent reconfiguration for the measurement report configuration where, depending on the height/altitude, the UE can apply specific set of parameters to the periodic and event/conditional event report configurations. An example of the list of parameters are as shown above.

The height/altitude-dependent reconfiguration can be triggered based on certain events as configured by the network. For example, if the height/altitude of the UE is below/above a threshold for a certain time.

In another embodiment, the network can configure the UE with multiple set of height/altitude-dependent reconfiguration parameters which are then applied appropriately based on the events as mentioned in the previous embodiment.

In above embodiments, height/altitude threshold is described. However, this may be replaced or combined with speed threshold, RSRP threshold, location threshold or RSRP of N cells being above a threshold. N is a non-zero integer.

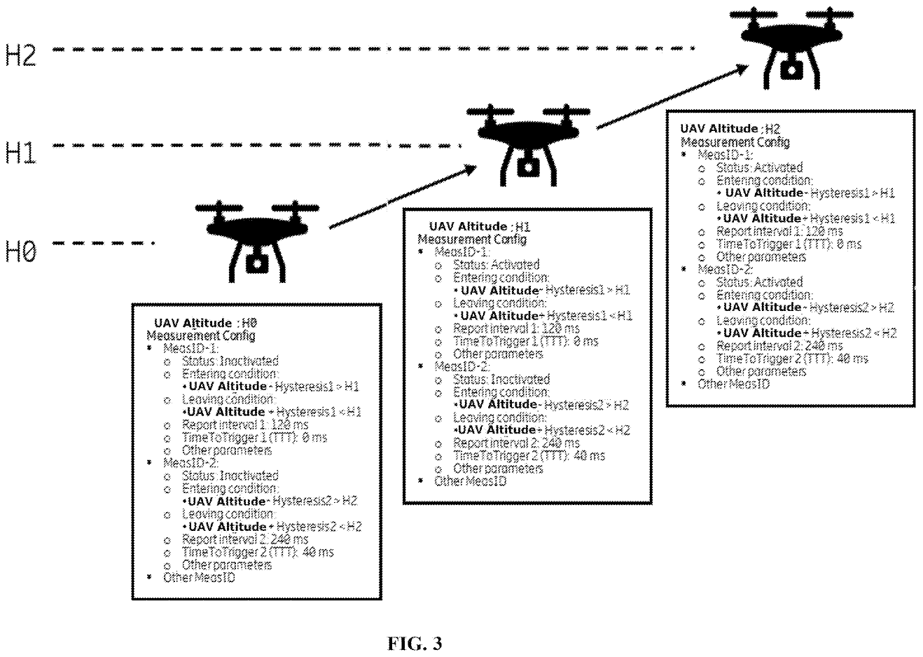

FIG. 3 is a diagram showing different measurement configurations associated with different conditions.

As shown in FIG. 3, at the altitude of H0, the UAV UE is configured with multiple sets of measurement report configurations, including configurations identified with MeasID-1 and MeasID-2 (both inactivated).

When the UAV UE rises to altitude H1 and satisfies the entering condition for MeasID-1, the configuration in MeasID-1 will be activated.

When the UAV UE rises to altitude H2 and satisfies the entering condition for MeasID-2, the configuration in MeasID-2 will be activated.

When the UAV UE goes down to an altitude lower than the threshold configured in the configuration for MeasID-1 or MeasID-2, the corresponding configuration will be deactivated.

As shown in FIG. 3, the configuration for MeasID-1 may include:
Entering condition:
   UAV altitude−Hysteresis1>H1
Leaving condition:
   UAV altitude+Hysteresis1<H1
Report interval 1: 120 ms
TimeToTrigger 1 (TTT): 0 ms
Other parameters.

The configuration for MeasID-2 may include:
Entering condition:
   UAV altitude−Hysteresis1>H2
Leaving condition:
   UAV altitude+Hysteresis1<H2
Report interval 2: 240 ms
TimeToTrigger 2 (TTT): 40 ms
Other parameters.

A following altitude range parameter in IE MeasObject (subIE shown below) may be introduced.

[[

| | |
|---|---|
| ssb-ToMeasureAltitudeBasedList-r18 | SetupRelease { SSB-ToMeasureAltitudeBasedList- |

r18 } OPTIONAL
]]
}
SSB-ToMeasureAltitudeBasedList-r18 ::= SEQUENCE (SIZE (1..maxNrofAltitudeRangers-r18)) OF SSB-
ToMeasureAltitudeBased-r18

| SSB-ToMeasureAltitudeBased-r18 ::= | | SEQUENCE { |
|---|---|---|
| altitudeRange-r18 | SEQUENCE { | |
| altitudeMin-r18 | Altitude-r18 | OPTIONAL, |
| altitudeMax-r18 | Altitude-r18 | OPTIONAL, |
| altitudeHyst-r18 | HysteresisAltitude-r18 | OPTIONAL |

},

| | | |
|---|---|---|
| ssb-ToMeasure-r18 | SSB-ToMeasure | OPTIONAL |

ssb-ToMeasureAltitudeBasedList

List of altitude-dependent ssb-ToMeasure. When the UE is within an altitude range indicated by altitudeRange, it ignores the ssb-ToMeasure (without suffix), and applies the corresponding ssb-ToMeasure-r18 if present, otherwise, if ssb-ToMeasure-r18 is absent, measures on all SS-blocks. When the UE is outside all the altitude ranges indicated by altitudeRange (if any), ssb-ToMeasure (without suffix) applies.

For each altitude range, altitudeMin and altitudeMax indicate the minimum and maximum altitudes in meters relative to sea level, respectively, and if included, altitudeHyst indicates hysteresis in meters for determination of the altitude range. I.e., when altitudeHyst is configured for an altitude range, the UE considers itself to have entered the range if altitudeMin≤UE altitude≤altitudeMax and after entering the range considers itself to be in the range while (altitudeMin−altitudeHyst)<UE altitude≤(altitudeMax+altitudeHyst).

For each altitudeRange, if altitudeMin is absent, value minAltitude-r18 is used and if altitudeMax is absent, value maxAltitude-r18 is used.

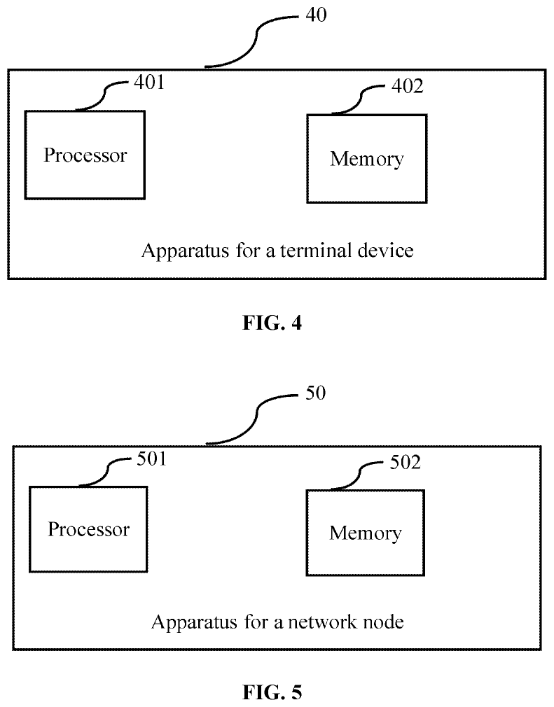

FIG. 4 is a block diagram showing an exemplary apparatus for a terminal device, which is suitable for performing the method according to embodiments of the disclosure.

As shown in FIG. 4, the apparatus 40 for the terminal device comprises: a processor 401, a memory 402. The memory 402 contains instructions executable by the processor 401. The apparatus 40 for the terminal device is operative for: receiving, from a network node, a measurement configuration associated with a condition; optionally determining whether the condition is met; and performing a measurement and/or transmitting a report based on the measurement configuration, when the condition is met. The condition is related to a first height/altitude range and/or a time period that the terminal device is in or out of a first height/altitude range.

In embodiments of the present disclosure, the apparatus 40 is further operative to perform the method according to any of the above embodiments, such as shown in FIG. 1A, 1B, FIG. 3, etc.

FIG. 5 is a block diagram showing an exemplary apparatus for a network node, which is suitable for performing the method according to embodiments of the disclosure.

As shown in FIG. 5, the apparatus 50 for the network node comprises: a processor 501, a memory 502. The memory 502 contains instructions executable by the processor 501. The apparatus 50 for the network node is operative for: transmitting, to a terminal device, a measurement configuration associated with a condition. The condition is related to a first height/altitude range and/or a time period that the terminal device is in or out of a first height/altitude range. The condition is used for the terminal device to determine whether the condition is met; and to perform a measurement and/or transmit a report based on the measurement configuration, when the condition is met.

In embodiments of the present disclosure, the apparatus 50 is further operative to perform the method according to any of the above embodiments, such as shown in FIG. 2A, 2B, FIG. 3, etc.

The processors 401, 501 may be any kind of processing component, such as one or more microprocessor or microcontrollers, as well as other digital hardware, which may include digital signal processors (DSPs), special-purpose digital logic, and the like. The memories 402, 502 may be any kind of storage component, such as read-only memory (ROM), random-access memory, cache memory, flash memory devices, optical storage devices, etc.

Particularly, the terminal device may be a UE referring to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The processors 401, 501 may be configured to process instructions and data and may be configured to implement any sequential state machine operative to execute instructions stored as machine-readable computer programs in the memory. The processors 401, 501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processors 401, 501 may include multiple central processing units (CPUs).

The memories 402, 502 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memories 402, 502 include one or more application programs, such as an operating system, web browser application, a widget, gadget engine, or other application, and corresponding data. The memories 402, 502 may store, for use by the UE, any of a variety of various operating systems or combinations of operating systems.

The memories 402, 502 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory may allow the UE to access instructions, application programs and the like, stored on transitory or non-transitory memory media, to off-load data, or to upload data. An article of manufacture, such as one utilizing a communication system may be tangibly embodied as or in the memories 402, 502, which may be or comprise a device-readable storage medium.

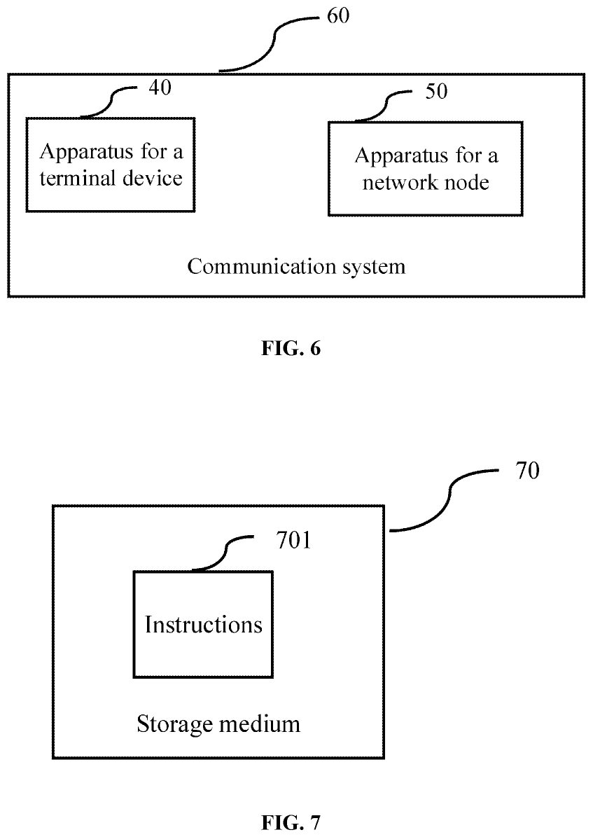

FIG. 6 is a block diagram showing a communication system including a terminal device and a network node.

As shown in FIG. 6, a communication system 60 may include the apparatus 40 for a terminal device, and an apparatus 50 for a network node.

The apparatus 40 may be as above illustrated in reference to FIG. 4, and the apparatus 50 may be above illustrated in reference to FIG. 5.

FIG. 7 is a block diagram showing an apparatus/computer readable storage medium, according to embodiments of the present disclosure.

As shown in FIG. 7, the computer-readable storage medium 70, or any other kind of product, storing instructions 701 which when executed by at least one processor, cause the at least one processor to perform the method according to any one of the above embodiments, such as these shown in FIG. 1A, 1B, FIG. 2A, 2B, FIG. 3, etc.

In addition, the present disclosure may also provide a carrier containing the computer program as mentioned above, the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

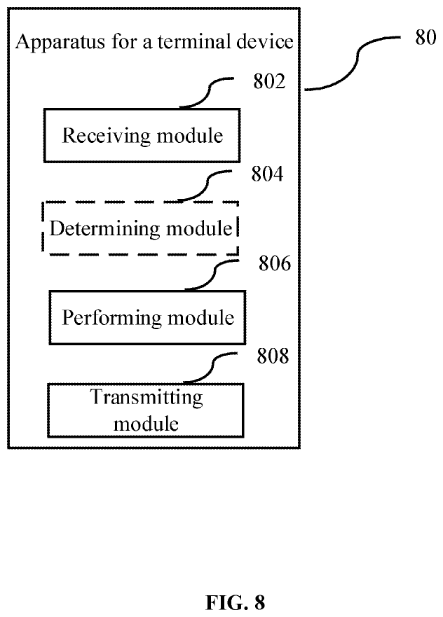

FIG. 8 is a block diagram showing modules for a terminal device, which are suitable for performing the method according to embodiments of the disclosure.

As shown in FIG. 8, the apparatus 80 for the terminal device may comprise: a receiving unit 802, configured for receiving, from a network node, a measurement configuration associated with a condition; an optional determining unit 804, configured for determining whether the condition is met; and a performing unit 806 and/or a transmitting unit 808, configured for performing a measurement and/or transmitting a report based on the measurement configuration, when the condition is met. The condition is related to a first height/altitude range and/or a time period that the terminal device is in or out of a first height/altitude range.

In embodiments of the present disclosure, the apparatus 80 is further operative to perform the method according to any of the above embodiments, such as these shown in FIG. 1A, 1B, FIG. 3, etc.

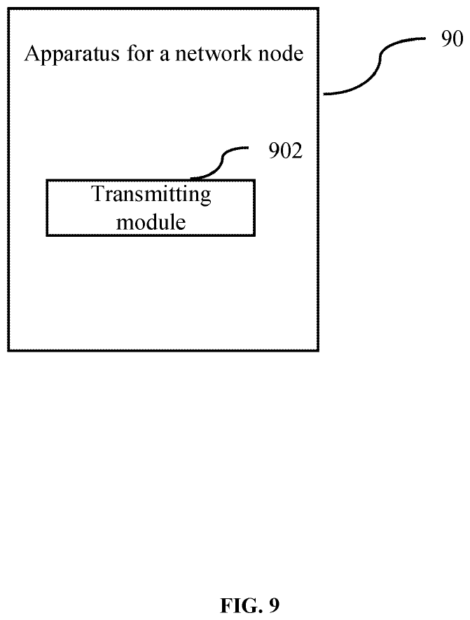

FIG. 9 is a block diagram showing modules for a network node, which are suitable for performing the method according to embodiments of the disclosure.

As shown in FIG. 9, the apparatus 90 for the network node may comprise: a transmitting module 902, configured for transmitting, to a terminal device, a measurement configuration associated with a condition. The condition is related to a first height/altitude range and/or a time period that the terminal device is in or out of a first height/altitude range. The condition is used for the terminal device to determine whether the condition is met; and to perform a measurement and/or transmit a report based on the measurement configuration, when the condition is met.

In embodiments of the present disclosure, the apparatus 90 is further operative to perform the method according to any of the above embodiments, such as these shown in FIG. 2A, 2B, FIG. 3, etc.

These modules may include, for example, electrical and/or electronic circuitry, devices, units, processors, memories, logic solid state and/or discrete devices, computer programs or instructions for carrying out respective tasks, procedures, computations, outputs, and/or displaying functions, and so on, as such as those that are described herein.

With these modules, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

Particularly, these function modules may be implemented either as a network element on a dedicated hardware, as a software instance running on a dedicated hardware, or as a virtualized function instantiated on an appropriate platform, e.g., on a cloud infrastructure.

Some detailed implementation circumstances for the embodiments of the present disclosure may be further illustrated below.

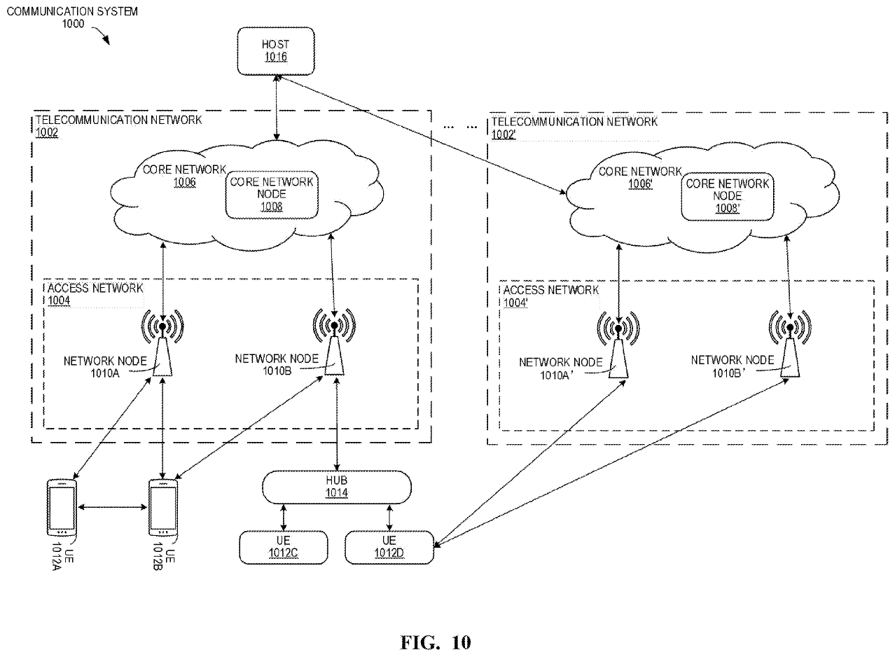

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The communication system 1000 includes a telecommunication network 1002′ that includes an access network 1004′, such as a radio access network (RAN), and a core network 1006′, which includes one or more core network nodes 1008′. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The access network 1004′ includes one or more access network nodes, such as network nodes 1010a′ and 1010b′ (one or more of which may be generally referred to as network nodes 1010′), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

A UE may be connected to more than one telecommunication network. As an example without limitation, the UE 1012D is connected to a plurality of networks including the telecommunication network 1002 and 1002′. The UE 1012D may perform the method according to embodiments of the present disclosure to transmit data by aggerating the telecommunication network 1002 and 1002′.

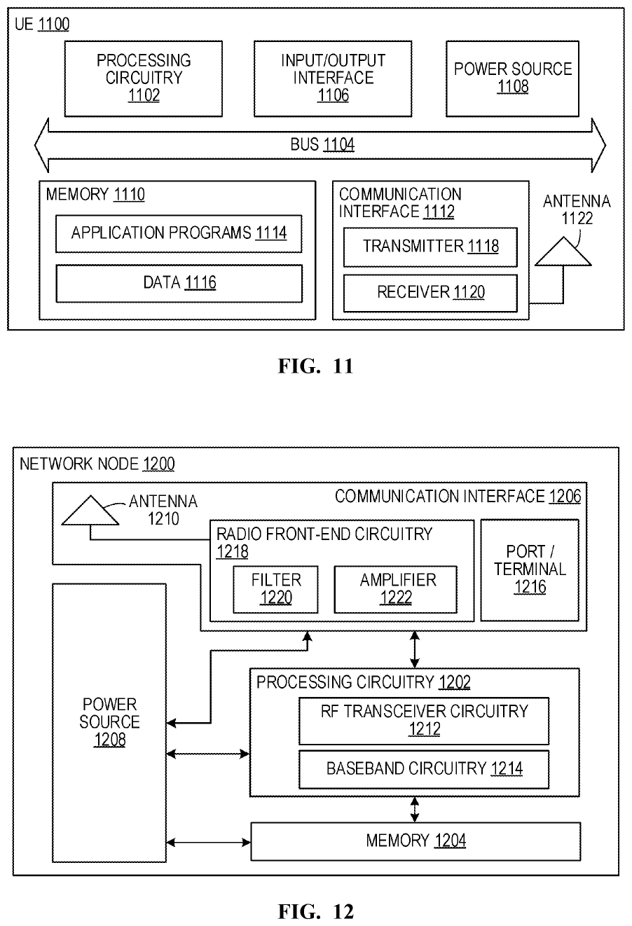

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

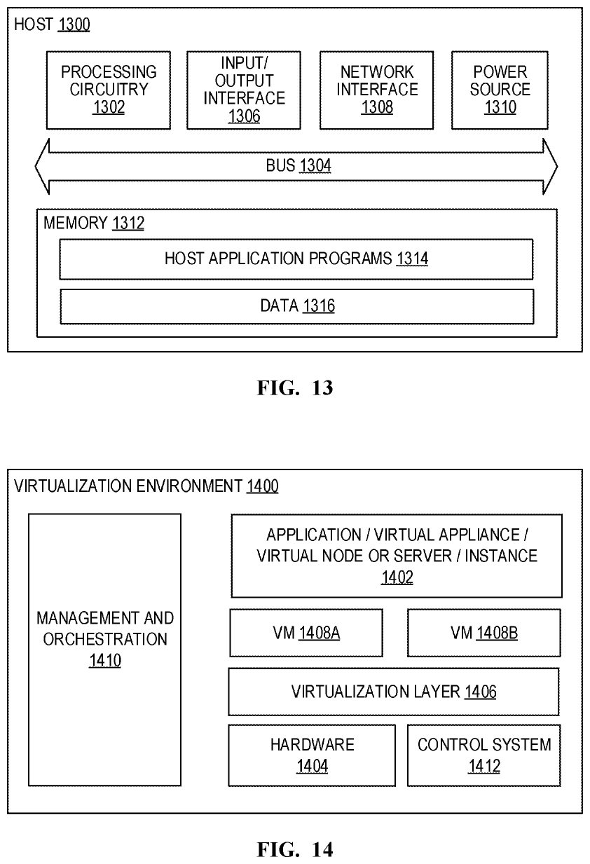

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

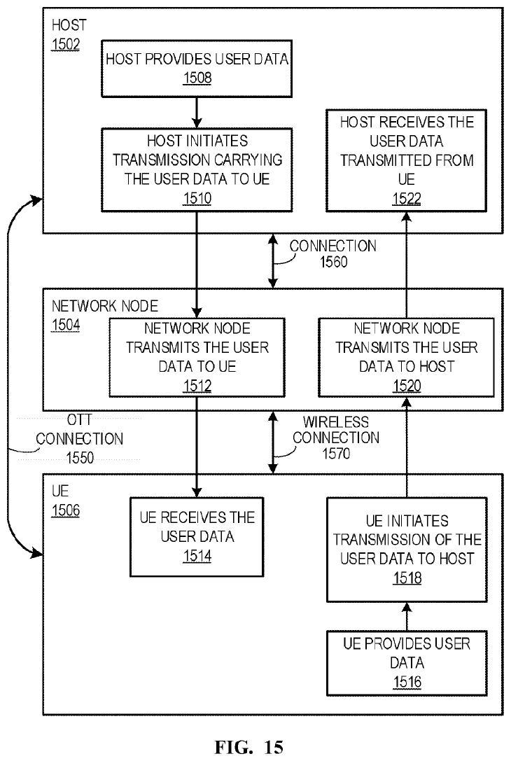

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. According to embodiments of the present disclosure, improved methods and improved apparatuses for applying configuration at terminal device are provided. By associating at least one measurement configuration to at least one condition, the configuration can be applied only when the condition is met. Therefore, at least one measurement configuration may be configured previously but applied respectively based on the condition. More precisely, the teachings of these embodiments may improve the performance, e.g., data rate, latency, power consumption, of the communication network, and thereby provide benefits such as reduced user waiting time, relaxed restriction on file size, improved content resolution, better responsiveness, extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The followings are the references which are incorporated herein in their entirety:
3GPP TS 38.331-h10, V17.1.0 (2022-06), 3rd Generation Partnership Project; Technical Specification Group Radio Access Network; NR; Radio Resource Control (RRC) protocol specification (Release 17).

| ABBREVIATION | EXPLANATION |
|---|---|
| AUE | Aerial UE |
| CLI | Cross Link Interference |
| PCI | Physical cell identity |
| RSRP | Reference Signal Received Power |
| RSRQ | Reference Signal Received Quality |
| RSSI | Received Signal Strength Indicator |
| SINR | Signal to Interference & Noise Ratio |
| SIB | System Information Block |
| SIM | Subscriber identity module |
| UAV | Uncrewed Aerial Vehicle, Unmanned Aerial vehicle |
| UE | User equipment |
| 3D | Three Dimension |
| RRC | Radio Resource Control |
| RS | Reference Signal |
| SS/PBCH | Synchronization Signal/Physical Broadcast Channel |
| | block |
| CSI-RS | Channel-State-Information Reference Signal |
| RRM | Radio Resource Management |
| IE | Information Element |

1.-39. (canceled)

40. A method performed by a terminal device, the method comprising:
receiving, from a network node, a measurement configuration associated with a condition; and
performing a measurement and/or transmitting a report based on the measurement configuration, when the condition is met;
wherein the condition is related to a first height/altitude range and/or a time period that the terminal device is in or out of a first height/altitude range.

41. The method according to claim 40, further comprising determining whether the condition is met.

42. The method according to claim 40,
wherein the measurement configuration includes a first set of configuration parameters and a second set of configuration parameters;
wherein the condition includes a first condition and a second condition; and
wherein the first set of configuration parameters is associated with the first condition and/or wherein the second set of configuration parameters is associated with the second condition.

43. The method according to claim 42,
wherein the terminal device performs a measurement and/or transmits a report based on the first set of configuration parameters, when the first condition is met; and/or
wherein the terminal device performs a measurement and/or transmits a report based on the second set of configuration parameters, when the second condition is met.

44. The method according to claim 40, wherein the measurement configuration is associated with a measurement configuration identity.

45. The method according to claim 44, wherein the measurement configuration, identified by the measurement configuration identity, is pre-configured for the condition, and wherein the method further comprises transmitting, to the network node, a request for an update to the measurement configuration indicated by the measurement configuration identity.

46. The method according to claim 40, wherein the first height/altitude range is indicated by at least one parameter, and wherein the at least one parameter comprises:
a height/altitude with an offset;
a bottom threshold of height/altitude; and/or
a top threshold of height/altitude.

47. The method according to claim 40, wherein the measurement configuration includes at least one parameter indicating a second height/altitude range, and wherein the method further comprises determining the condition as being met when the second height/altitude range overlaps with the first height/altitude range.

48. The method according to claim 40, further comprising receiving, from the network node, a reconfiguration for the measurement, wherein the reconfiguration is triggered based on an event related to a height/altitude of the terminal device.

49. The method according to claim 40, wherein the condition is further related to at least one of: a speed of the terminal device, a location of the terminal device, a time, and/or a signal characteristic measured by the terminal device.

50. The method according to claim 40, wherein the measurement configuration comprises at least one of: a measurement object, a report interval, a report amount, a maximal number of report cells, an event threshold, an event hysteresis, and/or a time to trigger related to an event.

51. The method according to claim 50, wherein an event hysteresis is configured for at least one event threshold.

52. The method according to claim 50, wherein a reference signal received power (RSRP) or a reference signal received quality (RSRQ) measurement is reported, when the condition is met.

53. The method according to claim 40,
wherein the measurement configuration comprises a list of height/altitude ranges; and
wherein a height/altitude range in the list of height/altitude ranges is indicated by a combination of a minimum height/altitude, a maximum height/altitude, and/or a hysteresis for height/altitude.

54. The method according to claim 53, wherein the measurement configuration indicates that the terminal device measures a synchronization signal block (SSB) corresponding to a height/altitude range, when the terminal device is within the height/altitude range.

55. The method according to claim 40,
wherein the terminal device is a user equipment (UE); and/or
wherein the network node is a base station.

56. The method according to claim 55, wherein the terminal device is an aerial UE.

57. A method performed by a network node, the method comprising:
transmitting, to a terminal device, a measurement configuration associated with a condition;
wherein the condition is related to a first height/altitude range and/or a time period that the terminal device is in or out of a first height/altitude range;
wherein the condition is used for the terminal device to perform a measurement and/or transmit a report based on the measurement configuration, when the condition is met.

58. The method according to claim 57, further comprising: transmitting, to the terminal device, a reconfiguration for the measurement, wherein the reconfiguration is triggered based on an event related to a height/altitude of the terminal device.

59. An apparatus for a terminal device, comprising:
a processor; and
a memory, the memory containing instructions executable by the processor;
wherein the apparatus for the terminal device is operative for:
receiving, from a network node, a measurement configuration associated with a condition; and
performing a measurement and/or transmitting a report based on the measurement configuration, when the condition is met;
wherein the condition is related to a first height/altitude range and/or a time period that the terminal device is in or out of a first height/altitude range.
